(19) United States
(12) Patent Application Publication
(10) Pub. No.: US 2026/0242570 A1
(43) Pub. Date: Aug. 20, 2026

(54) EPOXY RESIN COMPOSITION

(71) Applicant: THREEBOND CO., LTD., Tokyo (JP)

(72) Inventors: Jyunya IWASAWA, Tokyo (JP); Yusuke IMAI, Tokyo (JP); Koki MIHASHI, Tokyo (JP)

(21) Appl. No.: 18/992,628

(22) PCT Filed: Jul. 27, 2023
(86) PCT No.: PCT/JP2023/027516

§ 371 Date: Jan. 9, 2025

(30) Foreign Application Priority Data
Jul. 29, 2022 (JP) 2022-121296

(51) Int. Cl. C08K 5/37; C08K 5/17; C08K 9/06

(52) U.S. Cl. CPC C08K 5/37; C08K 5/17; C08K 9/06; C08K 2201/005

(57) ABSTRACT

An epoxy resin composition contains components (A) to (D): component (A): an epoxy resin; component (B): a compound having two or more thiol groups in one molecule; component (C): a curing accelerator; and component (D): a filler. A content of an epoxy resin containing no aromatic ring in one molecule is 9.5% by mass or less with respect to a total mass of the component (A). The epoxy resin composition contains 25% by mass or less of the component (D) with respect to the overall composition.

### TECHNICAL FIELD

The present invention relates to an epoxy resin composition with low outgassing during curing.

### BACKGROUND ART

In the assembly of electronic components such as semiconductors, there are cases where outgassing from an adhesive or a pressure-sensitive adhesive affects the assembly process. In Domestic Re-publication of PCT International Application Publication No. 2020-184199 (corresponding to EP 3940764 A1), a process of prebaking (preheating) a pressure-sensitive adhesive, thereby causing outgassing in advance, is taken to reduce outgassing. However, the multi-step process would increase running costs. On the other hand, a low-molecular-weight component is sometimes added to an adhesive in order to improve workability, but the low-molecular-weight component tends to volatilize and is likely to be outgassed.

### SUMMARY OF INVENTION

### Technical Problem

Conventionally, a low-molecular-weight component tends to volatilize when added in order to improve workability, making it difficult to minimize outgassing of the element.

Accordingly, the present invention has been made in view of the above circumstances, and an object thereof is to provide a technique for minimizing outgassing during curing (particularly, even when a component having a low molecular weight is added). Another object of the present invention is to provide an epoxy resin composition that can cure at a low temperature.

As a result of intensive studies to achieve the objects, the present inventors have found a method relating to an epoxy resin composition with low outgassing during curing, and have thus completed the present invention.

The gist of the present invention will be described below. A first embodiment of the present invention is an epoxy resin composition comprising components (A) to (D):
component (A): an epoxy resin;
component (B): a compound having two or more thiol groups in one molecule;
component (C): a curing accelerator; and
component (D): a filler,
in which a content of an epoxy resin containing no aromatic ring in one molecule is 9.5% by mass or less with respect to a total mass of the component (A), and a content of the component (D) is 25% by mass or less with respect to the overall composition.

A second embodiment of the present invention is the epoxy resin composition according to the first embodiment, in which the component (A) comprises a compound having one epoxy group in one molecule (including a compound having an aromatic ring in one molecule and only one epoxy group in one molecule) and a compound having two or more epoxy groups in one molecule (including a compound having an aromatic ring in one molecule and two or more epoxy groups in one molecule).

A third embodiment of the present invention is the epoxy resin composition according to the second embodiment, in which the compound having one epoxy group in one molecule is contained in a proportion of 0.1 to 30% by mass with respect to the total mass of the component (A).

A fourth embodiment of the present invention is the epoxy resin composition according to the second or third embodiment, in which the compound having two or more epoxy groups in one molecule comprises an epoxy resin containing no aromatic ring in one molecule and an epoxy resin containing an aromatic ring in one molecule.

A fifth embodiment of the present invention is the epoxy resin composition according to any one of the first to fourth embodiments, in which the component (C) is an epoxy adduct-type amine compound.

A sixth embodiment of the present invention is the epoxy resin composition according to any one of the first to fifth embodiments, in which the component (D) is an inorganic filler surface-treated with phenylaminosilane.

A seventh embodiment of the present invention is the epoxy resin composition according to the sixth embodiments, in which the inorganic filler is silica.

An eighth embodiment of the present invention is the epoxy resin composition according to any one of the first to seventh embodiments, in which the component (D) has a 50% average particle size of 0.1 to 50 μm.

A ninth embodiment of the present invention is an epoxy resin composition for non-contact jet dispensing comprising the epoxy resin composition according to any one of the first to eighth embodiments.

A tenth embodiment of the present invention is a cured product formed by heat-curing the epoxy resin composition according to any one of the first to eighth embodiments.

An eleventh embodiment of the present invention is the cured product according to the tenth embodiment, which has a heating loss of 0.40% by mass or less during curing.

A twelfth embodiment of the present invention is the cured product according to the tenth or eleventh embodiment, in which a surface curing time during curing is 950 seconds or less.

A thirteenth embodiment of the present invention is an epoxy resin composition having a heating loss of 0.40% by mass or less during curing as measured with a thermogravimetric differential thermal analyzer, in which a surface curing time is 950 seconds or less as measured with a rigid-body pendulum type physical property tester.

A fourteenth embodiment of the present invention is the epoxy resin composition according to the thirteenth embodiment, comprising components (A) to (D):
component (A): an epoxy resin;
component (B): a compound having two or more thiol groups in one molecule;
component (C): a curing accelerator; and component (D): a filler.

The present invention relates to an epoxy resin composition comprising components (A) to (D):
component (A): an epoxy resin;
component (B): a compound having two or more thiol groups in one molecule;
component (C): a curing accelerator; and
component (D): a filler,
in which a content of an epoxy resin containing no aromatic ring in one molecule is 9.5% by mass or less with respect to a total mass of the component (A), and the epoxy resin composition comprises 25% by mass or less of the component (D) with respect to the overall composition.

The epoxy resin composition according to the present invention is capable of minimizing outgassing during curing even when a low-molecular-weight component (e.g., a component having a molecular weight of 225 or less) is added in order to improve workability (even in the case of a low viscosity composition) and can cure at a low temperature (in particular, the surface curing time at 80° C. is within 950 seconds, particularly less than 900 seconds). Here, the “surface curing time” is measured according to the method described in the section of Examples below.

The viscosity of the epoxy resin composition is less than 1200 (mPa·s), preferably 1000 (mPa·s) or less, and more preferably 800 (mPa·s) or less. The lower limit of the viscosity of the epoxy resin composition is preferably as low as possible. The viscosity is thus not particularly limited but is, for example, 100 (mPa·s) or more. The “viscosity” is measured according to the method described in the section of Examples below.

In the present invention, “minimizing outgassing during curing” can be evaluated with a thermogravimetric differential thermal analyzer (TG/DTA) using a heating loss (% by mass) during curing as an indicator. Specifically, if the heating loss during curing measured according to [Measurement of heating loss during curing] described in the section of Examples below is less than 0.42% by mass, it is determined that outgassing during curing can be minimized. The heating loss during curing measured according to [Measurement of heating loss during curing] described in the section of Examples below is preferably 0.40% by mass or less, more preferably 0.35% by mass or less, and particularly preferably 0.30% by mass or less.

Next, the present invention will be described in detail. Note that the present invention is not limited to the following embodiments, and various modifications can be made within the scope of the appended claims. In addition, the embodiments described herein can be arbitrarily combined into other embodiments.

Throughout this specification, any expression in a singular form should be understood to encompass the concept of its plural form, unless otherwise specified. Therefore, a singular article (e.g., “a”, “an”, and “the” in English) should be understood to encompass the concept of its plural form, unless otherwise specified. In addition, any term used herein should be understood to have the meaning commonly used in the art, unless otherwise specified. Accordingly, unless defined otherwise, all technical and scientific terms used herein have the same meaning as generally understood by those skilled in the art to which the present invention pertains. In case of any conflict, the present specification (including the definitions) takes priority.

In the present specification, the numerical range “X to Y” includes X and Y and means “X or more and Y or less”.

The component (A) that can be used in the present invention is a compound having one or more epoxy groups in one molecule. The component (A) is also referred to as an epoxy resin. Furthermore, to reduce outgassing during curing, the content of an epoxy resin containing no aromatic ring in one molecule is 9.5% by mass or less with respect to the total mass of the component (A). When the content of the epoxy resin containing no aromatic ring in one molecule exceeds 9.5% by mass with respect to the total mass of the components (A), the proportion of an epoxy resin containing an aromatic ring in one molecule becomes too small to sufficiently minimize outgassing during curing. From the viewpoint of further effectively reducing outgassing during curing, the content of the epoxy resin containing no aromatic ring in one molecule is preferably 9.0% by mass or less, and more preferably 8.0% by mass or less with respect to the total mass of the component (A). The content of the epoxy resin containing no aromatic ring in one molecule is preferably 5.0% by mass or more, more preferably more than 6.0% by mass, and particularly preferably 6.5% by mass or more with respect to the total mass of the component (A). To achieve low viscosity and maintain the strength of a cured product, the component (A) is preferably composed of a compound having one epoxy group in one molecule and a compound having two or more epoxy groups in one molecule. The compound having one epoxy group in one molecule is preferably contained in a proportion of 0.1 to 30% by mass, more preferably contained in a proportion of 5 to 30% by mass, and particularly preferably contained in a proportion of 10 to 20% by mass with respect to the total mass of the component (A).

Furthermore, to reduce outgassing during curing, the compound having two or more epoxy groups in one molecule is preferably composed of an epoxy resin containing no aromatic ring in one molecule and an epoxy resin containing an aromatic ring in one molecule. Although a clear reason is not known, the epoxy resin containing an aromatic ring in one molecule can function to suppress volatilization outside the composition as an outgassing component, and the epoxy resin containing no aromatic ring in one molecule can function to decrease the viscosity of the composition. Note that the above is a presumption, and the present invention is not limited by the above mechanism.

Examples of a compound containing an aromatic ring in one molecule and having two or more epoxy groups in one molecule include, but are not limited to, a bisphenol A-type epoxy resin, a bisphenol F-type epoxy resin, a bisphenol S-type epoxy resin, a bisphenol AD-type epoxy resin, a phthalene-type epoxy resin, a dicyclopentadiene-type epoxy resin, a phenol novolac resin, a cresol novolac resin, a biphenyl-type epoxy resin, a glycidylamine-type epoxy resin, and oxyalkylene modified products thereof, which may be liquid, semi-solid, or solid at 25° C. In addition, these compounds may be used alone or as a mixture of two or more thereof. Specific examples thereof include, but are not limited to, jER series such as 825, 827, 828, 828EL, 828XA, 828US, 806, 806H, 807, 152, 871, 872, YL980, YL983U, YX8000, YX8034, and 834 manufactured by Mitsubishi Chemical Corporation; EPICLON series such as 840, 840S, 850, 850S, 850CRP, 850-LC, 830, 835, EXA-830LVP, EXA-830LVP, EXA-835LV, and N-730A manufactured by DIC Corporation; EP series such as 4100, 4100G, 4100E, 4300E, 4530, 4901, 4901E, and 4000L manufactured by ADEKA Corporation; and DENACOL series such as EX-810, EX-811, EX-850, EX-821, EXA-920, EX-201, and EX-212 manufactured by Nagase ChemteX Corporation.

Examples of a compound containing an aromatic ring in one molecule and having only one epoxy group in one molecule include, but are not limited to, methylphenyl glycidyl ether, ethylphenyl glycidyl ether, propylphenyl glycidyl ether, butylphenyl glycidyl ether, pentylphenyl glycidyl ether, hexylphenyl glycidyl ether, heptylphenyl glycidyl ether, octylphenyl glycidyl ether, nonylphenyl glycidyl ether, decylphenyl glycidyl ether, 4-tert-butylphenyl glycidyl ether, and 4-sec-butylphenyl glycidyl ether. The compound is preferably liquid at 25° C. Specific examples thereof include, but are not limited to, DENACOL series such as EX-141, EX-142-IM, EX-145, and EX-146 manufactured by Nagase ChemteX Corporation; and ADEKA GLYCIROL series such as ED-509E, ED-509S, and ED-529 manufactured by ADEKA Corporation, which may be liquid, semi-solid, or solid at 25° C. In addition, these compounds may be used alone or as a mixture of two or more thereof.

Examples of a compound containing no aromatic ring in one molecule and having two or more epoxy groups in one molecule include, but are not limited to, sorbitol polyglycidyl ether, sorbitol polyglycidyl ether, sorbitol polyglycidyl ether, sorbitol polyglycidyl ether, glycerol polyglycidyl ether, glycerol polyglycidyl ether, trimethylolpropane polyglycidyl ether, trimethylolpropane polyglycidyl ether, diglycerol polyglycidyl ether, polyglycerol polyglycidyl ether, polyglycerol polyglycidyl ether, ethylene glycol diglycidyl ether, ethylene glycol diglycidyl ether, ethylene glycol diglycidyl ether, polyethylene glycol diglycidyl ether, polyethylene glycol diglycidyl ether, polyethylene glycol diglycidyl ether, polyethylene glycol diglycidyl ether, polyethylene glycol diglycidyl ether, polyethylene glycol diglycidyl ether, polyethylene glycol diglycidyl ether, resorcinol diglycidyl ether, neopentyl glycol diglycidyl ether, 1,6-hexanediol diglycidyl ether, 1,4-butanediol diglycidyl ether, hydrogenated bisphenol A diglycidyl ether, polypropylene glycol diglycidyl ether, and 1,3-bis(2, 3-epoxypropoxy)-2, 2-dimethylpropane. The compound is preferably liquid at 25° C. Specific examples thereof include, but are not limited to, DENACOL series such as EX-612, EX-614, EX-614B, EX-313, EX-314, EX-421, EX-512, EX-521, EX-1610, EX-321, EX-321L, EX-622, EX-810, EX-810P, EX-811, EX-850, EX-851, EX-821, EX-830, EX-832, EX-841, EX-861, EX-214L, EX-920, EX-201, EX-201-IM, EX-211, EX-212, EX-212L, EX-252, EX-931, and EX-991L manufactured by Nagase ChemteX Corporation; and ADEKA GLYCIROL series such as ED-503, ED-503G, ED-506, ED-523T, ED-523L, and ED-505 manufactured by ADEKA Corporation, which may be liquid, semi-solid, or solid at 25° C. In addition, these compounds may be used alone or as a mixture of two or more thereof.

To improve the reliability of the cured product, the component (A) is preferably used as a liquid at 25° C. and as a semi-solid or solid at 25° C. in combination. The softening point of the semi-solid or solid component (A) is preferably 40 to 200° C., more preferably 50 to 150° C., and most preferably 55 to 130° C. If the softening point is 40 to 200° C., an epoxy resin composition with good compatibility with the component (A) and low viscosity can be obtained. As used herein, the term “semi-solid” particularly refers to the range of P to U as measured by a Gardner/Holtz method. The viscosity measurement method by the Gardner-Holtz method is a measurement method of expressing the rising speed of bubbles in a standard glass tube at a constant temperature by A to Z and Z1 to 10 for comparison with a standard viscosity, and + and − are given in the case of being before and after each indicator. When the semi-solid or solid component (A) is added, from the viewpoint of initial curability, the semi-solid or solid component (A) is preferably contained in a proportion of 5 to 20% by mass, more preferably 8 to 15% by mass, with respect to the total mass of the components (A).

The component (B) that can be used in the present invention is a compound having two or more thiol groups in one molecule, which may be used alone or in combination with two or more thereof. Specific examples of the component (B) include, but are not limited to, an aliphatic polythiol compound, an aromatic polythiol compound, and a polythiol compound having a sulfide bond.

Examples of an aliphatic polythiol compound having two thiol groups include, but are not limited to, 1,2-ethanedithiol, 1,2-propanedithiol, 1,3-propanedithiol, 1,4-butanedithiol, 1,6-hexanedithiol, 1,7-heptanedithiol, 1,8-octanedithiol, 1,9-nonanedithiol, 1,10-decanedithiol, 1,12-dodecanedithiol, 2,2-dimethyl-1,3-propanedithiol, 3-methyl-1,5-pentanedithiol, 2-methyl-1,8-octanedithiol, 1,4-cyclohexanedithiol, 1,4-bis(mercaptomethyl)cyclohexane, 1,1-cyclohexanedithiol, 1,2-cyclohexanedithiol, bicyclo[2,2,1]hepta-exo-cis-2,3-dithiol, 1,1-bis(mercaptomethyl)cyclohexane, bis(2-mercaptoethyl) ether, ethylene glycol bis(2-mercaptoacetate), and ethylene glycol bis(3-mercaptopropionate).

Examples of an aliphatic polythiol compound having three thiol groups include, but are not limited to, 1,1,1-tris(mercaptomethyl)ethane, 2-ethyl-2-mercaptomethyl-1,3-propanedithiol, 1,2,3-propanetrithiol, trimethylolpropane tris(2-mercaptoacetate), trimethylolpropane tris(3-mercaptopropionate), and tris[(mercaptopropionyloxy)-ethyl]isocyanurate.

Examples of an aliphatic polythiol compound having four or more thiol groups include, but are not limited to, pentaerythritol tetrakis(2-mercaptoacetate), pentaerythritol tetrakis(3-mercaptopropionate), pentaerythritol tetrakis(3-mercaptobutyrate), and dipentaerythritol hexa-3-mercaptopropionate.

Examples of the aromatic polythiol compound include, but are not limited to, 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,2-bis(2-mercaptoethyl)benzene, 1,3-bis(2-mercaptoethyl)benzene, 1,4-bis(2-mercaptoethyl)benzene, 1,2-bis(2-mercaptoethyleneoxy)benzene, 1,3-bis(2-mercaptoethyleneoxy)benzene, 1,4-bis(2-mercaptoethyleneoxy)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(2-mercaptoethyl)benzene, 1,2,4-tris(2-mercaptoethyl)benzene, 1,3,5-tris(2-mercaptoethyl)benzene, 1,2,3-tris(2-mercaptoethyleneoxy)benzene, 1,2,4-tris(2-mercaptoethyleneoxy)benzene, 1,3,5-tris(2-mercaptoethyleneoxy)benzene, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(2-mercaptoethyl)benzene, 1,2,3,5-tetrakis(2-mercaptoethyl)benzene, 1,2,4,5-tetrakis(2-mercaptoethyl)benzene, 1,2,3,4-tetrakis(2-mercaptoethyleneoxy)benzene, 1,2,3,5-tetrakis(2-mercaptoethyleneoxy)benzene, 1,2,4,5-tetrakis(2-mercaptoethyleneoxy)benzene, 2,2′-mercaptobiphenyl, 4,4′-thiobisbenzenethiol, 4,4′-dimercaptobiphenyl, 4,4′-dimercaptobibenzyl, 2,5-toluenedithiol, 3,4-toluenedithiol, 1,4-naphthalenedithiol, 1,5-naphthalenedithiol, 2,6-naphthalenedithiol, 2,7-naphthalenedithiol, 2,4-dimethylbenzene-1,3-dithiol, 4,5-dimethylbenzene-1,3-dithiol, 9,10-anthracenedimethanethiol, 1,3-bis(2-mercaptoethylthio)benzene, 1,4-bis(2-mercaptoethylthio)benzene, 1,2-bis(2-mercaptoethylthiomethyl)benzene, 1,3-bis(2-mercaptoethylthiomethyl)benzene, 1,4-bis(2-mercaptoethylthiomethyl)benzene, 1,2,3-tris(2-mercaptoethylthio)benzene, 1,2,4-tris(2-mercaptoethylthio)benzene, 1,3,5-tris(2-mercaptoethylthio)benzene, 1,2,3,4-tetrakis(2-mercaptoethylthio)benzene, 1,2,3,5-tetrakis(2-mercaptoethylthio)benzene, and 1,2,4,5-tetrakis(2-mercaptoethylthio)benzene.

Examples of the polythiol compound having a sulfide bond include, but are not limited to, bis(2-mercaptoethyl) sulfide, bis(2-mercaptoethylthio)methane, 1,2-bis(2-mercaptoethylthio)ethane, 1,3-bis(2-mercaptoethylthio)propane, 1,2,3-tris(2-mercaptoethylthio)propane, tetrakis(2-mercaptoethylthiomethyl)methane, 1,2-bis(2-mercaptoethylthio)propanethiol, 2,5-dimercapto-1,4-dithiane, bis(2-mercaptoethyl) disulfide, 3,4-thiophenedithiol, 1,2-bis(2-mercaptoethyl)thio-3-mercaptopropane, and bis-(2-mercaptoethylthio-3-mercaptopropane) sulfide.

Specific examples of a component (B) having a secondary thiol group include, but are not limited to, pentaerythritol tetrakis(3-mercaptobutyrate), 1,4-bis(3-mercaptobutyryloxy)butane, 1,3,5-tris(3-mercaptobutyryloxyethyl)-1,3,5-triazine-2,4,6(1H,3H,5H)-trione, trimethylolpropane tris(3-mercaptobutyrate), trimethylolethane tris(3-mercaptobutyrate), trimethylolpropane tris(3-mercaptobutyrate), and trimethylolethane tris(3-mercaptobutyrate). Examples of a commercial product thereof include, but are not limited to, PEMP manufactured by SC Organic Chemical Co., Ltd.; and PE1, BD1, and NR1 of Karenz MT(R) series manufactured by Showa Denko K.K.

The component (B) is preferably contained in an amount of 10 to 90 parts by mass based on 100 parts by mass of the component (A). The component (B) is more preferably contained in an amount of 20 to 80 parts by mass, particularly preferably in an amount of 40 to 80 parts by mass with respect to 100 parts by mass of the component (A). Low-temperature curability is maintained when the component (B) is contained in an amount of 10 parts by mass or more, and storage stability is improved when the component (B) is contained in an amount of 90 parts by mass or less.

The component (C) that can be used in the present invention is a curing accelerator. The component (C) may be any substance that accelerates the polymerization of the components (A) and (B). In particular, when the component (B) with high purity is used, the components (A) and (B) do not cure by themselves even when heated for a long time, but the addition of the component (C) results in the development of curability. Examples of the component (C) include an aliphatic amine compound, a cycloaliphatic amine compound, an aromatic amine compound, a urea compound, imidazole, a polyamide compound, a hydrazide compound, dicyandiamide, an epoxy adduct-type amine compound, and derivatives thereof, which may be used alone or in combination with two or more thereof. Among them, it is preferable to use a curing accelerator prepared by grinding an epoxy adduct-type amine compound produced by stopping a reaction of adding an epoxy resin to primary to tertiary amines in the middle, from the viewpoint of low-temperature curing. In other words, the component (C) preferably contains an epoxy adduct-type amine compound, and more preferably, the component (C) is an epoxy adduct-type amine compound. For example, a curing agent that is a mixture of an epoxy compound-modified amine and a urea-modified amine can be used as the component (C). Examples of the primary to tertiary amines to be used include imidazole, urea, and am amine compound. From the viewpoint of dispersion in the composition, the component (C) has a 50% average particle size of preferably 0.1 to 20 μm, and more preferably 5.0 to 10.0 μm. Note that the particle size can be confirmed by using a particle size/shape distribution measuring device of laser diffraction scattering type or microsorting control type, and image analysis, for example, by an optical microscope, an electron microscope. The 50% average particle size means the particle size at an integrated value of 50% in the particle size distribution according to a laser diffraction scattering method, which is hereinafter also simply referred to as the average particle size.

Specific examples of powder of the epoxy adduct-type amine compound include, but are not limited to, AJICURE series such as PN-23, PN-23J, PN-31, PN-31J, PN-40J, PN-H, PN-R, MY-24, and MY-R manufactured by Ajinomoto Fine-Techno Co., Inc; and Fujicure series such as FXE-1000, FXR-1030, and FXR-1081 manufactured by T & K TOKA Corporation. Specific examples of the imidazole include, but are not limited to, CUREZOL series SIZ, 2MZ-H, C11Z, C17Z, 2PZ, 2PZ-PW, and 2P4MZ manufactured by Shikoku Chemicals Corporation.

The component (C) is preferably contained in an amount of 1 to 20 parts by mass based on 100 parts by mass of the component (A). The component (C) is more preferably contained in an amount of 1 to 10 parts by mass, and particularly preferably 3 to 6 parts by mass with respect to 100 parts by mass of the component (A). Low-temperature curability is improved when the component (C) is contained in an amount of 1 part by mass or more, and storage stability is maintained when the component (B) is contained in an amount of 20 parts by mass or less.

The component (C) is preferably contained in an amount of 0.5 to 15 parts by mass, more preferably in an amount of 3 to 7 parts by mass, and particularly preferably in an amount of 3.0 to 5.0 parts by mass with respect to 100 parts by mass of the total of the components (A) and (B). Low-temperature curability is improved when the component (C) is contained in an amount of 0.5 parts by mass or more, and storage stability is maintained when the component (C) is contained in an amount of 15 parts by mass or less.

The component (D) used in the present invention is a filler and accounts for 25% by mass or less of the overall composition. Generally, the more the component (D) is added to the composition, the more the outgassing tends to be reduced. Although a clear cause is not known, it has been found that outgassing that occurs during curing is minimized when the amount of the component (D) is small. Although this remains a matter of speculation, the addition of a large amount of the component (D) is considered to inhibit the polymerization reaction of organic components of the components (A) to (C) and to prevent the network formation, resulting in volatilization of the low-molecular-weight component because it is heated in such a state. From the viewpoint of further reducing outgassing during curing, the content of the component (D) is preferably less than 19.3% by mass, more preferably 19.0% by mass or less, with respect to the overall composition. In addition, the content of the component (D) is usually 5% by mass or more with respect to the overall composition, and from the viewpoint of further reducing outgassing during curing, preferably 10% by mass or more, more preferably 15% by mass or more. From the viewpoint of reducing outgassing during curing, the amount (content) of the component (D) added per 100 parts by mass of the total of the component (A) is 50 parts by mass or less, more preferably 40 parts by mass or less. The amount (content) of the component (D) added per 100 parts by mass of the total of the component (A) is, for example, 20 parts by mass or more, and from the viewpoint of reducing outgassing during curing, preferably 30 parts by mass or more. Preferably, the amount (content) of the component (D) added per 100 parts by mass of the total of the components (A) and (B) is 35 parts by mass or less, and from the viewpoint of reducing outgassing during curing, more preferably less than 30 parts by mass, particularly preferably less than 25.0 parts by mass. The amount (content) of the component (D) added per 100 parts by mass of the total of the components (A) and (B) is, for example, 15 parts by mass or more, and from the viewpoint of reducing outgassing during curing, preferably 20.0 parts by mass or more, more preferably 23.0 parts by mass or more.

Of fillers, an inorganic filler is particularly preferable, and examples thereof include, but are not limited to, silica powder, fumed silica powder, alumina powder, calcium carbonate powder, talc powder, nickel powder, palladium powder, carbon powder, tungsten powder, and plating powder. Among these, the inorganic filler is preferably silica powder, fumed silica powder, alumina powder, and more preferably silica. Examples of the shape of one particle of the filler include a spherical shape, an amorphous shape, and a needle-like shape, and a spherical shape is preferable from the viewpoint of permeability to a gap. Similarly, from the viewpoint of improving permeability, the 50% average particle size is preferably 0.1 to 50 μm, more preferably 0.1 to 5 μm, even more preferably 0.1 to 3 μm, and most preferably 0.1 to 1 μm. The specific surface area is preferably 1.0 to 10.0 m²/g, and more preferably 3.0 to 8.0 m²/g.

In consideration of compatibility with the components (A) and (B), a filler with surface-treated particles is preferable. In particular, a filler surface-treated with phenylaminosilane is preferable. That is, the component (D) is preferably an inorganic filler surface-treated with phenylaminosilane, in this case, the inorganic filler is more preferably silica. It can be obtained by reacting a hydroxyl group present on the surface of the inorganic filler with phenylaminosilane. The phenylaminosilane referred to in the present invention is an alkoxysilane having a phenylamino group. Examples thereof include N-phenyl-γ-aminopropyltrimethoxysilane, N-phenyl-γ-aminopropyltriethoxysilane, 3-phenylaminopropyltrimethoxysilane, and 3-phenylaminopropyltriethoxysilane, among which N-phenyl-γ-aminopropyltrimethoxysilane and N-phenyl-γ-aminopropyltriethoxysilane are preferable, and N-phenyl-γ-aminopropyltrimethoxysilane is more preferable, from the viewpoint of permeability.

Specific examples of the silica powder include FUSELEX E-1 manufactured by Tatsumori Ltd. and AO-802 manufactured by Admatechs Company Limited, and examples of amorphous silica include, but are not limited to, AEROSIL series such as 200 (not treated), R972 (treated with dimethyldichlorosilane), R976 (treated with dimethyldichlorosilane), RY200 (treated with dimethyl silicone), RX200 (treated with hexamethyldisilazane), and R800 (treated with octylsilane) manufactured by NIPPON AEROSIL CO., LTD.; and SXJ2500-SXJ (treated with N-phenyl-γ-aminopropyltrimethoxysilane) manufactured by Admatechs Company Limited, which may be used alone or in combination with two or more thereof.

In the present invention, an additive such as a coupling agent, an organic filler, a storage stabilizer, a colorant (excluding the component (D)) such as a pigment and a dye (e.g., carbon black), an antioxidant, a polymerization inhibitor, an antifoaming agent, a leveling agent, a surfactant, and a rheology control agent may be incorporated in an appropriate amount to the extent that the characteristics of the present invention are not impaired. A composition or a cured product thereof excellent in resin strength, adhesive strength, workability, storage stability and the like can be obtained by addition of such an additive.

In the present invention, a coupling agent can be added to the extent that characteristics of the present invention are not impaired. Examples of the coupling agent include, but are not limited to, a silane-based coupling agent having both an epoxy group, a vinyl group, an acryloyl group, or a methacryloyl group and a hydrolyzable silane group, polyorganosiloxane having a phenyl group and a hydrolyzable silyl group, and/or polyorganosiloxane having an epoxy group and a hydrolyzable silyl group. Specific examples of the silane-based coupling agent include, but are not limited to, allyltrimethoxysilane, vinyltrimethoxysilane, 3-glycidoxypropyltrimethoxysilane, 3-methacryloxypropyltrimethoxysilane, 3-acryloxypropyltrimethoxysilane, and 3-chloropropyltrimethoxysilane.

In the present invention, an organic filler can be added to the extent that the characteristics of the present invention are not impaired. The addition of a filler allows adjustment of not only viscosity and thixotropy but also curability and toughness. Examples of the organic filler include, but are not limited to, a styrene filler, a rubber filler, and a core-shell acrylic filler.

In the present invention, a storage stabilizer can be added to the extent that the characteristics of the present invention are not impaired. Examples of the storage stabilizer that can be used include boric acid ester, phosphoric acid, alkyl phosphate ester, and p-toluenesulfonic acid. Examples of the boric acid ester include, but are not limited to, tributyl borate, trimethoxyboroxine, and ethyl borate. Examples of the alkyl phosphate ester that can be used include, but are not limited to, trimethyl phosphate and tributyl phosphate. The storage stabilizer may be used alone or as a mixture of two or more. In consideration of the influence on cure shrinkage, one or more selected from the group consisting of phosphoric acid, alkyl phosphate ester, boric acid ester, trimethoxyboroxine, and methyl p-toluenesulfonate are preferable, and phosphoric acid and boric acid ester are most preferable. From the viewpoint of maintaining curability and storage stability, a suitable blending amount of the storage stabilizer is 0.1 to 10 parts by mass with respect to 100 parts by mass of the component (A).

The epoxy resin composition according to the present invention is preferably an epoxy resin composition that contains the components (A) to (D), a storage stabilizer, a surfactant, and a colorant as essential components, but not other components, in consideration of a reduction in outgassing during curing.

In other words, an epoxy resin composition in a preferred embodiment of the present invention is substantially composed of the components (A) to (D), wherein a content of an epoxy resin containing no aromatic ring in one molecule is 9.5% by mass or less with respect to a total mass of the component (A) and the epoxy resin composition comprises 25% by mass or less of the component (D) with respect to the overall composition. In a preferred embodiment of the present invention, the epoxy resin composition is composed of the components (A) to (D), wherein a content of an epoxy resin containing no aromatic ring in one molecule is 9.5% by mass or less with respect to a total mass of the component (A) and the epoxy resin composition comprises 25% by mass or less of the component (D) with respect to the overall composition.

In a preferred embodiment of the present invention, the epoxy resin composition is substantially composed of the components (A) to (D) and at least one selected from the group consisting of a storage stabilizer, a surfactant, and a colorant, wherein a content of an epoxy resin containing no aromatic ring in one molecule is 9.5% by mass or less with respect to a total mass of the component (A) and the epoxy resin composition comprises 25% by mass or less of the component (D) with respect to the overall composition. In a preferred embodiment of the present invention, the epoxy resin composition is composed of the components (A) to (D) and at least one selected from the group consisting of a storage stabilizer, a surfactant, and a colorant, wherein a content of an epoxy resin containing no aromatic ring in one molecule is 9.5% by mass or less with respect to a total mass of the component (A) and the epoxy resin composition comprises 25% by mass or less of the component (D) with respect to the overall composition.

As used herein, the phrase “substantially composed of X1, X2, . . . Xn” means that the total content of X1, X2, . . . Xn in the epoxy resin composition is more than 95% by mass, and preferably, the total content of X1, X2, . . . Xn in the epoxy resin composition is 99% by mass or more (upper limit: 100% by mass). As used herein, the phrase “composed of X1, X2, . . . Xn” means that the total content of X1, X2, . . . Xn in the epoxy resin composition is 100% by mass.

A method of applying the present invention to an adherent includes a method of using a known sealant or an adhesive, such as needle application, non-contact jet dispensing, spraying, screen printing, gravure printing, dipping, and spin coating. In consideration of workability and productivity, the viscosity (at 25° C.) of the epoxy resin composition of the present invention is preferably 100 to 1000 mPa-s, and the epoxy resin composition having such a viscosity can be used in non-contact jet dispensing. In other words, the present invention also provides an epoxy resin composition for non-contact jet dispensing containing the epoxy resin composition of the present invention.

In the curing conditions of the present invention, the heating temperature is preferably 50 to 200° C. and more preferably 70 to 150° C., and the heating time is preferably 5 to 180 minutes and more preferably 10 to 90 minutes.

As a result, the epoxy resin composition according to the present invention is cured to form a cured product, that is, the present invention also provides a cured product formed by heat-curing the epoxy resin composition according to the present invention.

The epoxy resin composition of the present invention is capable of minimizing outgassing during curing, and specifically, the heating loss during heating is less than 0.42% by mass (preferably 0.4% by mass or less, more preferably 0.35% by mass or less, and particularly preferably 0.30% by mass or less), that is, the cured product according to the above aspect preferably has a heating loss of 0.40% by mass or less during curing.

The epoxy resin composition of the present invention also allows for surface curing in a short time. Specifically, the surface curing time during curing is 950 seconds or less and preferably less than 900 seconds, that is, the surface curing time during curing is preferably 950 seconds or less in the cured product according to the above aspect. In the present specification, the “surface curing time” or “surface curing time during curing” is a value measured according to the method described in the section of [Measurement of rigid-body pendulum type physical property] of Examples below.

The present invention also provides an epoxy resin composition having a heating loss of 0.40% by mass or less during curing as measured with a thermogravimetric differential thermal analyzer, in which a surface curing time is 950 seconds or less as measured with a rigid-body pendulum type physical property tester.

In the above aspect, the epoxy resin composition contains the following components (A) to (D), which are the same as those in the above epoxy resin composition, and therefore, description thereof will be omitted here:
component (A): an epoxy resin;
component (B): a compound having two or more thiol groups in one molecule;
component (C): a curing accelerator; and
component (D): a filler.

In heating during curing, outgassing is measured as a heating loss with a thermogravimetric differential thermal analyzer (TG/DTA). It has been found using a rigid-body pendulum type physical property tester that the amount of outgassing also depends on how quickly the surface is cured during heating. In particular, when the component (D) accounts for 25% by mass or less of the total composition, outgassing tends to be reduced. The content of the component (D) is more preferably 5 to 25% by mass, and most preferably by 10 to 20% by mass. Although a clear cause is not known, it is assumed that when the content of the component (D) is more than 25% by mass, the component (D) physically blocks the crosslinking (polymerization) of the resin, thus preventing the crosslinking from proceeding. If a low-molecular-weight compound with high volatility or a solvent having no functional group, such as an epoxy group, remains in the composition, outgassing is assumed to occur from the composition during curing upon heating in a state where crosslinking does not proceed so much. Note that the above is a presumption, and the present invention is not limited to the above. In particular, it is preferable that a compound having an aliphatic hydrocarbon structure, an organofluorine compound (PFAS), and the like are not contained in the composition because these compounds are easily outgassed.

### EXAMPLES

Next, the present invention will be described in more detail with reference to Examples, but the present invention is not limited only to these Examples (hereinafter, the epoxy resin composition is also simply referred to as a composition).

### Examples 1 to 7 and Comparative Examples 1 to 3

The following components were provided to prepare a composition.

### Component (A): A Compound Having One or More Epoxy Groups in One Molecule

Mixture of bisphenol A-type epoxy resin and bisphenol F-type epoxy resin (EPICLON(R) EXA-835LV, manufactured by DIC Corporation)
Bisphenol A-type epoxy resin in semi-solid form at 25° C. (jER(R) 834, manufactured by Mitsubishi Chemical Corporation)
EO-modified bisphenol A-type diglycidyl ether (ADEKA RESIN EP-4000L, manufactured by ADEKA Corporation)
1,3-Bis(2,3-epoxypropoxy)-2,2-dimethylpropane (ADEKA GLYCIROL ED-523L, manufactured by ADEKA Corporation, molecular weight=216)
t-Butylphenyl glycidyl ether (ADEKA GLYCIROL ED-509S, manufactured by ADEKA Corporation, molecular weight=206)

### Component (B): A Compound Having Two or More Thiol Groups in One Molecule

Pentaerythritol tetrakis(3-mercaptobutyrate) (Karenz MT PE1, manufactured by Showa Denko K.K.)

### Component (C): A Curing Accelerator

Curing agent (having a 50% average particle size of 6.0 μm), which is a mixture of an epoxy compound-modified amine and a urea-modified amine (Fujicure FXR-1081, manufactured by T&K TOKA Corporation)

### Component (D): A Filler

Spherical silica surface-treated with phenylaminosilane (N-phenyl-γ-aminopropyltrimethoxysilane) having a 50% average particle size of 0.5 μm and a specific surface area of 6.0 m2/g (SXJ2500-SXJ, manufactured by Admatechs Company Limited)

### Other Component

Carbon black (Mitsubishi Carbon Black MA100, manufactured by Mitsubishi Chemical Corporation)

The components (A), (B), and (D), and the other components were weighed into a stirring tank, followed by stirring with vacuum defoaming for 30 minutes. Finally, the component (C) was weighed and added to the stirring tank, followed by stirring for 30 minutes. Detailed preparation amounts are given in Table 1, and all values are expressed in parts by mass. Table 1 also shows the total mass of the component (A), the proportion (% by mass) of the component (A) containing no aromatic ring in the component (A), the component (D) per 100 parts by mass of the total of the component (A), the total mass of the components (A) and (B), the component (D) per 100 parts by mass of the total of the components (A) and (B), and the proportion (% by mass) of the component (D) to the overall composition.

TABLE 1

| | | | | | | | | | | Compar- | Compar- | Compar- |
|---|---|---|---|---|---|---|---|---|---|---|---|---|
| | | | Exam- | Exam- | Exam- | Exam- | Exam- | Exam- | Exam- | ative | ative | ative |
| | Raw | Aromatic | ple | ple | ple | ple | ple | ple | ple | Exam- | Exam- | Exam- |
| Component | Material | Ring | 1 | 2 | 3 | 4 | 5 | 6 | 7 | ple 1 | ple 2 | ple 3 |
| Component | EXA-835LV | contained | 31.5 | 41.0 | 29.7 | 26.6 | 29.7 | 31.5 | 31.5 | 30.8 | 31.5 | 31.5 |
| (A) | jER834 | contained | 11.8 | 10.2 | 16.9 | 10.0 | 11.1 | 11.8 | 11.8 | 11.6 | 11.8 | 11.8 |
| | EP-4000L | contained | 35.4 | 30.5 | 33.4 | 45.4 | 33.4 | 35.4 | 35.4 | 34.7 | 35.4 | 35.4 |
| | ED-523L | not contained | 7.9 | 6.8 | 7.4 | 6.7 | 7.4 | 7.9 | 7.9 | 9.9 | 7.9 | 7.9 |
| | ED-509S | contained | 13.4 | 11.5 | 12.6 | 11.3 | 18.4 | 13.4 | 13.4 | 13.1 | 13.4 | 13.4 |
| Component | PE1 | — | 55.1 | 47.4 | 52.0 | 46.6 | 52.0 | 55.1 | 79.0 | 53.9 | 55.1 | 55.1 |
| (B) | | | | | | | | | | | | |
| Component | FXR-1081 | — | 5.9 | 5.1 | 5.6 | 5.0 | 5.6 | 9.0 | 5.9 | 5.8 | 5.9 | 5.9 |
| (C) | | | | | | | | | | | | |
| Component | SC2500-SXJ | — | 39.4 | 33.9 | 37.1 | 33.3 | 37.1 | 39.4 | 39.3 | 38.5 | 59.6 | 79.8 |
| (D) | | | | | | | | | | | | |
| Other | MA100 | — | 1.2 | 1.0 | 1.1 | 1.0 | 1.1 | 1.2 | 1.2 | 1.2 | 1.2 | 1.2 |
| component | | | | | | | | | | | | |

| | | | | | | | | | | |
|---|---|---|---|---|---|---|---|---|---|---|
| Total | 201.6 | 187.4 | 195.8 | 185.9 | 195.8 | 204.6 | 225.3 | 199.3 | 221.8 | 241.9 |
| Total mass of component (A) | 100.0 | 100.0 | 100.0 | 100.0 | 100.0 | 100.0 | 100.0 | 100.0 | 100.0 | 100.0 |
| Proportion of component (A) | 7.9 | 6.8 | 7.4 | 6.7 | 7.4 | 7.9 | 7.9 | 9.9 | 7.9 | 7.9 |
| containing no aromatic ring | | | | | | | | | | |
| in component (A) | | | | | | | | | | |
| Component (D) per 100 parts by | 39.4 | 33.9 | 37.1 | 33.3 | 37.1 | 39.4 | 39.3 | 38.5 | 59.6 | 79.8 |
| mass of total mass of component | | | | | | | | | | |
| (A) | | | | | | | | | | |
| Total mass of components (A) and | 155.1 | 147.4 | 152.0 | 146.6 | 152.0 | 155.1 | 179.0 | 153.9 | 155.1 | 155.1 |
| (B) | | | | | | | | | | |
| Component (D) per 100 parts | 25.4 | 23.0 | 24.4 | 22.7 | 24.4 | 25.4 | 22.0 | 25.0 | 38.4 | 51.4 |
| by mass of total mass of | | | | | | | | | | |
| components (A) and (B) | | | | | | | | | | |
| Proportion of component (D) | 19.5 | 18.1 | 19.0 | 17.9 | 19.0 | 19.2 | 17.4 | 19.3 | 26.9 | 33.0 |
| to overall composition | | | | | | | | | | |

Viscosity and heating loss during curing were measured for Examples 1 to 7 and Comparative Examples 1 to 3 according to the methods described below. The results are summarized in Table 2.

### [Measurement of Viscosity]

After stirring with a polytetrafluoroethylene rod, 2.0 cc of the composition was weighed to measure viscosity using a Brookfield digital viscometer (model number: DV-2+Pro) while the temperature was set at 25° C. with a temperature controller. The measurement was made under such conditions that a cone rotor used was CPE-52 (3°×R 1.2) at a shear rate of 76.8 (1/s). The viscosity after 3 minutes was defined as “viscosity (mPa·s)”.

### [Measurement of Heating Loss During Curing]

First, 10 mg of the composition was weighed in an aluminum vessel and set in a thermogravimetric differential thermal analyzer TG/DTA220 manufactured by Seiko Instruments Inc. The temperature was then raised to 80° C. at a heating rate of 10° C./min and maintained for 70 minutes. The “heating loss during curing (% by mass)” (outgassing) was calculated by (initial mass−mass at the end of measurement)/initial mass×100. The heating loss during curing may be less than 0.42% by mass and is preferably 0.40% by mass or less, more preferably 0.35% by mass or less, and particularly preferably 0.30% by mass or less.

TABLE 2

| Test | Example | Example | Example | Example | Example | Example | Example | Comparative | Comparative | Comparative |
|---|---|---|---|---|---|---|---|---|---|---|
| Item | 1 | 2 | 3 | 4 | 5 | 6 | 7 | Example 1 | Example 2 | Example 3 |
| Viscosity | 700 | 800 | 1000 | 650 | 400 | 800 | 600 | 650 | 1200 | 2000 |
| (mPa · s) | | | | | | | | | | |
| Heating | 0.33 | 0.27 | 0.34 | 0.39 | 0.29 | 0.34 | 0.28 | 0.46 | 0.59 | 0.42 |
| loss | | | | | | | | | | |
| during | | | | | | | | | | |
| curing | | | | | | | | | | |
| (% by | | | | | | | | | | |
| mass) | | | | | | | | | | |

Normally, the more the component (D) was added to the composition, the less the heating loss (outgassing) was expected during curing. However, a comparison of Examples 1 to 7 with Comparative Examples 2 and 3 revealed that the composition with a smaller amount of the component (D) had a lower heating loss. Although a clear cause was not known, the addition of a large amount of the component (D) was assumed to inhibit the polymerization reaction of organic components of the components (A) to (C) and prevent the network formation, resulting in volatilization of the low-molecular-weight component because it was heated in such a state. A comparison of Examples 1 to 7 with Example 1 showed that the epoxy resin containing no aromatic ring in one molecule accounted for 9.5% by mass or less of the total of the component (A), resulting in less heating loss during curing.

Additional measurements of rigid-body pendulum type physical properties were performed on Examples 1, 4, 6, and 7 and Comparative Examples 1 to 3 according to the following method. The results are summarized in Table 3 together with the results of the measurements of the heating loss on curing.

### [Measurement of Rigid-Body Pendulum Type Physical Property]

A rigid-body pendulum type physical property tester RPT-3000W manufactured by A&D Company, Limited was used as the measuring instrument. A test piece made of a cold-rolled steel sheet of 20 mm wide×50 mm long×0.3 mm thick was degreased, and then a spacer having a thickness of 100 μm was formed on the test piece at an interval of 10 mm. After the composition was applied and squeegeed, the spacer was peeled off to form a coating on the test piece. The test piece was set on a hotplate of the measuring instrument so that the edge was brought into contact with a predetermined position on the coating of the test piece at the start of the measurement by a rigid pendulum, FRB300, on which a flat knife edge, RBE160, had been set. The pendulum control condition was set with a measurement interval of 10 seconds and a pendulum adsorption time of 2 seconds, and the temperature was adjusted to 25° C. and left for 1 minute. Then, the measurement was started. After the start of the measurement, the logarithmic decrement was measured in a program in which the hotplate was heated from 25° C. to 80° C. at a heating rate of 10° C./min and held at 80° C. for 60 minutes. The attenuation of the swing width of the pendulum was measured when the composition started to cure with heating, and the elapsed time from the start of the measurement to the time when the logarithmic decrement reached a peak (local maximum) was defined as “surface curing time (seconds)”. The surface curing time is preferably 950 seconds or less, and more preferably less than 900 seconds.

TABLE 3

| | Surface curing | Heating loss during |
|---|---|---|
| | time (sec) | curing (% by mass) |
| Example 1 | 553 | 0.33 |
| Example 4 | 903 | 0.39 |
| Example 6 | 592 | 0.34 |
| Example 7 | 843 | 0.28 |
| Comparative | 1023 | 0.46 |
| Example 1 | | |
| Comparative | 952 | 0.59 |
| Example 2 | | |
| Comparative | 1033 | 0.42 |
| Example 3 | | |

A comparison of Examples 1, 4, 6, and 7 with Comparative Examples 1 to 3 in terms of the heating loss during curing, which is also described in Table 2 above, and surface curing time as measured with a rigid-body pendulum type physical property tester showed that the heating loss during curing would tend to be larger in a case where the surface curing time took longer. In particular, a comparison of Example 1, in which the component (D) accounts for 25% by mass or less of the overall composition, with Comparative Examples 2 and 3, in which the component (D) accounts for more than 25% by mass, indicated that in Example 1, the surface curing time was 950 seconds or less and the heating loss during curing was 0.40% by mass or less.

### INDUSTRIAL APPLICABILITY

In the assembly of electronic components such as semiconductors, the present invention can be used to minimize outgassing and realize low viscosity, thereby simplifying the process and improving workability.

The present application is based on Japanese Patent Application No. 2022-121296, filed on Jul. 29, 2022, the disclosure of which is incorporated herein by reference in its entirety.

1. An epoxy resin composition comprising components (A) to (D):
component (A): an epoxy resin;
component (B): a compound having two or more thiol groups in one molecule;
component (C): a curing accelerator; and
component (D): a filler,
wherein a content of an epoxy resin containing no aromatic ring in one molecule is 9.5% by mass or less with respect to a total mass of the component (A) and the epoxy resin composition comprises 25% by mass or less of the component (D) with respect to the overall composition.

2. The epoxy resin composition according to claim 1, wherein the component (A) comprises a compound having one epoxy group in one molecule and a compound having two or more epoxy groups in one molecule.

3. The epoxy resin composition according to claim 2, comprising 0.1 to 30% by mass of the compound having one epoxy group in one molecule with respect to the total mass of the component (A).

4. The epoxy resin composition according to claim 2, wherein the compound having two or more epoxy groups in one molecule comprises the epoxy resin containing no aromatic ring in one molecule and an epoxy resin containing an aromatic ring in one molecule.

5. The epoxy resin composition according to claim 1, wherein the component (C) is an epoxy adduct-type amine compound.

6. The epoxy resin composition according to claim 1, wherein the component (D) is an inorganic filler surface-treated with phenylaminosilane.

7. The epoxy resin composition according to claim 6, wherein the inorganic filler is silica.

8. The epoxy resin composition according to claim 1, wherein the component (D) has a 50% average particle size of 0.1 to 50 μm.

9. An epoxy resin composition for non-contact jet dispensing comprising the epoxy resin composition according to claim 1.

10. A cured product formed by heat-curing the epoxy resin composition according to claim 1.

11. The cured product according to claim 10, which has a heating loss of 0.40% by mass or less during curing.

12. The cured product according to claim 10, wherein a surface curing time during curing is 950 seconds or less.

13. An epoxy resin composition having a heating loss of 0.40% by mass or less during curing as measured with a thermogravimetric differential thermal analyzer, wherein a surface curing time is 950 seconds or less as measured with a rigid-body pendulum type physical property tester.

14. The epoxy resin composition according to claim 13, comprising components (A) to (D):
component (A): an epoxy resin;
component (B): a compound having two or more thiol groups in one molecule;
component (C): a curing accelerator; and
component (D): a filler.
